(19) United States
(12) Patent Application Publication
(10) Pub. No.: US 2010/0258751 A1
(43) Pub. Date: Oct. 14, 2010

(54) Borated Concrete-Rubber

(75) Inventor: Zeev Shayer, Littleton, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: COLORADO SEMINARY, WHICH OWNS AND OPERATES THE UNIVERSITY OF DENVER, Denver, CO (US)

(21) Appl. No.: 12/665,241

(22) PCT Filed: Jun. 20, 2008
(86) PCT No.: PCT/US08/67753

§ 371 Date: Apr. 26, 2010

Related U.S. Application Data
(60) Provisional application No. 60/945,156, filed on Jun. 20, 2007.

(51) Int. Cl. G21F 1/00; B29B 9/00

(52) U.S. Cl. 250/506.1; 523/136; 521/45.5

(57) ABSTRACT

A concrete material is disclosed according to one embodiment. The concrete material may include a mixture of cement, granular rubber and boron in various forms and ratios. The boron may include boron carbide. The rubber may be recovered rubber from used automobile and/or truck tires. Various other components may be added to the cement, such as, for example, binders, water, sand, rock, or other aggregates. Embodiments described herein may be used in radiation shielding applications, such as, for example, nuclear waste facilities, nuclear storage and/or transportation casks, nuclear power plants, medical waste facilities, illicit drug detection facilities, linear accelerator facilities, etc.

### CROSS-REFERENCES TO RELATED APPLICATIONS

This application is a non-provisional, and claims the benefit, of commonly assigned U.S. Provisional Application No. 60/945,156, filed Jun. 20, 2007, entitled “Borated Concrete-Rubber Combination for Concrete Structures and Radiation Shielding” the entirety of which is herein incorporated by reference for all purposes.

### BACKGROUND

This disclosure relates in general to concrete compositions and/or structures, such as concrete and/or concrete compositions for radiation shielding.

Concrete has been used for centuries. Modern concrete is a combination of cement, sand, aggregate and water in various combinations. Portland cement has been around since the early 19th century. Various improvements to concrete composition and/or structures have occurred over the years. For example, reinforced concrete was patented in 1878, fiber reinforcement was patented in 1982, and a concrete-rubber mixture was patented in 1994.

Concrete has also been used for shielding in casks used in nuclear waste storage, as well as in buildings and other structures that require radiation protection. For example, concrete-rubber has been disclosed as a material for structures that that has a few desirable characteristics such as lower density, higher impact and toughness resistance, enhanced ductility, and better sound insulation etc. These properties can be advantageous to some construction applications.

### BRIEF DESCRIPTION OF THE DRAWINGS

FIG. 1 shows a concrete slab containing granulated vulcanized rubber and boron carbide according to one embodiment.

FIGS. 2A and 2B show two storage casks implementing borated concrete rubber according to one embodiment.

FIGS. 2C and 2D show large storage facilities that may be constructed with borated concrete-rubber as described in various embodiments.

FIG. 3 shows nuclear fuel spent storage cask that may comprise borated concrete-rubber according to another embodiment.

FIGS. 4A, 4B, 4C and 4D show various graphs demonstrating various benefits of borated concrete-rubber according to one embodiment.

FIG. 5 shows a flow chart showing a method for making borated concrete-rubber according to one embodiment.

In the appended figures, similar components and/or features may have the same reference label. Where the reference label is used in the specification, the description is applicable to any one of the similar components having the same reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

Concrete provides relatively good shielding from radiation sources and has been used extensively in cask and storage facility construction. Concrete-rubber not only provides shielding from some radiation, but may also provide improved resistance to cracking, earthquakes, and shock waves. Accordingly, concrete-rubber may be used in, for example, nuclear storage facilities. There are limitations, however, to strict concrete-rubber. For instance, concrete-rubber does not provide good gamma ray shielding. Also, while concrete-rubber is a relatively good shield for neutrons it does not completely block them.

The present disclosure provides for concrete with improved radiation shielding properties according to one embodiment. A radioactive shield comprising a concrete mixture that includes a cement product, vulcanized or natural rubber and boron or boron containing compound, such as, for example, boron carbide (B₄C) according to some embodiments. Various mixtures of cement, vulcanized rubber and boron may be used. For example, a mixture may include 20-40% cement by weight, 5- 15% water by weight, 20-50% sand, aggregate and/or light aggregate by weight, 1-20% granulated rubbery by weight, and 0.1-10% boron or boron carbide by weight. In another embodiment, the amount of boron included in the mixture may be limited only by cost and/or structural considerations. Similarly the amount of rubber may also be limited on by the structural requirements. The vulcanized rubber may be derived from, for example, recycled tires or other rubber byproducts.

In various embodiments, the introduction of boron, such as, for example, boron carbide (B₄C) provides increased neutron absorption over concrete-rubber without boron. In some embodiments, the introduction of rubber to a combination of borated concrete likewise provides increased neutron absorption. Moreover, in some embodiments that include borated concrete-rubber, the boron provides greater neutron absorption than the concrete, the rubber and/or the combination of the two. Accordingly, the combination of cement, boron and rubber, as described throughout this disclosure, in various forms and/or ratios, and/or with various aggregates, provides better neutron shielding than any of these constituencies either singularly or in a sub-combination.

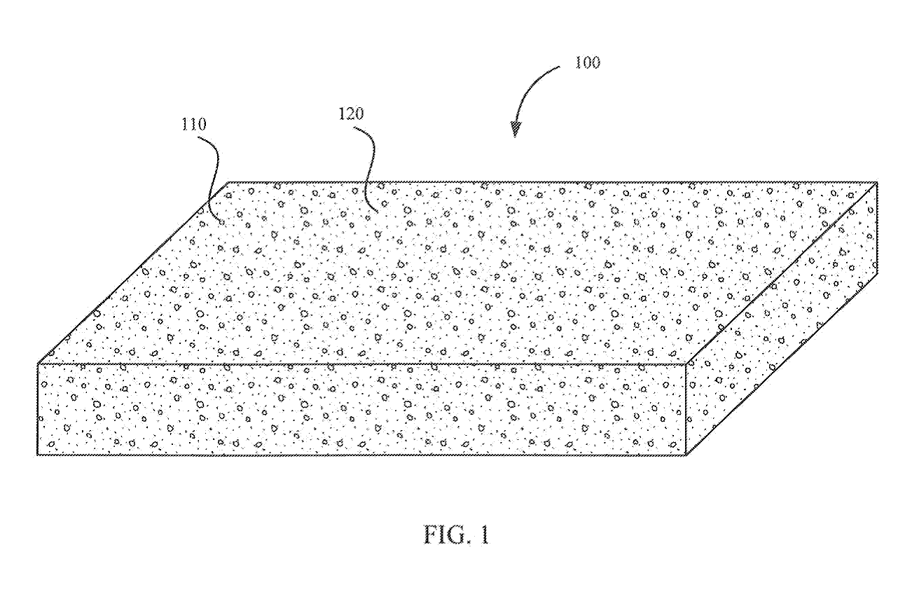

FIG. 1 shows a concrete slab 100 containing granulated vulcanized rubber 120 and boron carbide 110 according to one embodiment. The reset of the concrete slab may comprise, for example, Portland cement, water, aggregates and/or binders. As shown in the figure, the rubber granules 120 are generally larger than the boron carbide 110 particles . The rubber granules 120 may be in the form of powder, crumb, and/or chips. In some embodiments, the rubber granules 120 may have an average percent volume of about 0.1 to 5 cm³. In another embodiment, the rubber granules may have an average percent volume of about 0.5 to 3 cm³. In yet another embodiment, the rubber granules may have an average percent volume of about 1 to 2 cm³. The boron carbide may be in powder form and, while shown as a distinguishable particle in the figure, the boron carbide powder may be indistinguishable within the concrete slab.

While FIG. 1 shows an example of borated concrete-rubber as a slab, various other configurations may be used. In one embodiment, the borated concrete-rubber is provided as a mixture of at least concrete, boron and rubber granules or chunks. The borated concrete-rubber may be hydrated and poured into a frame. The frame may take nearly any form or shape. For example, the borated concrete-rubber may be poured into frames and formed into walls, floors, ceilings, enclosures, casks, containers, boxes, etc.

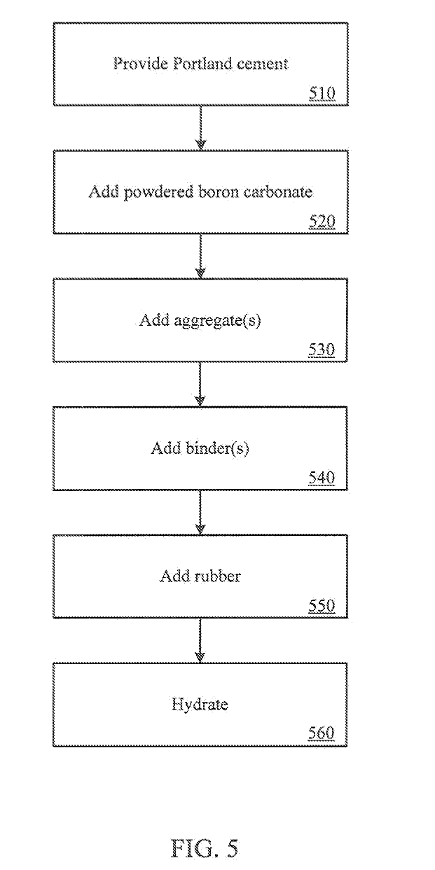

In another embodiment, Portland concrete in powder form is combined with a powdered boron compound, such as, boron carbide. Rubber granules may then be added to this mixture either before or after the addition of water. FIG. 5 shows a flow chart showing steps for making borated concrete-rubber according to one embodiment. In this embodiment, Portland cement is provided at block 510 and powdered boron carbide is added at block 520. At block 530 aggregates are added. These aggregates may include sand, gravel, rocks, or other materials. Optional binders may be included at block 540 and rubber granules are added in block 550. The rubber granules, for example, may be granulized used tires. At block 560, the mixture is hydrated by the addition of water. The various blocks may be rearranged in any order. For example, water may be added before the addition of rubber and/or the addition of boron carbide. As another example, binders may be added with the granulated rubber.

Borated concrete-rubber may have improved radiation shielding capabilities and may be used in various radiation shielding applications. For example, borated concrete-rubber may be used in nuclear fuel storage applications, construction materials, buildings, illicit drug detection facilities, linear accelerator facilities, hazardous material storage or processing buildings, nuclear power plants, nuclear weapon storage and or manufacturing facilities, medical waste facilities, nuclear waste treatment facilities, nuclear materials storage casks, transportation casks for transporting neutron sources, etc. In some embodiments, rubber added to the concrete may provide vibration and/or damping benefits as well as radiation shielding benefits.

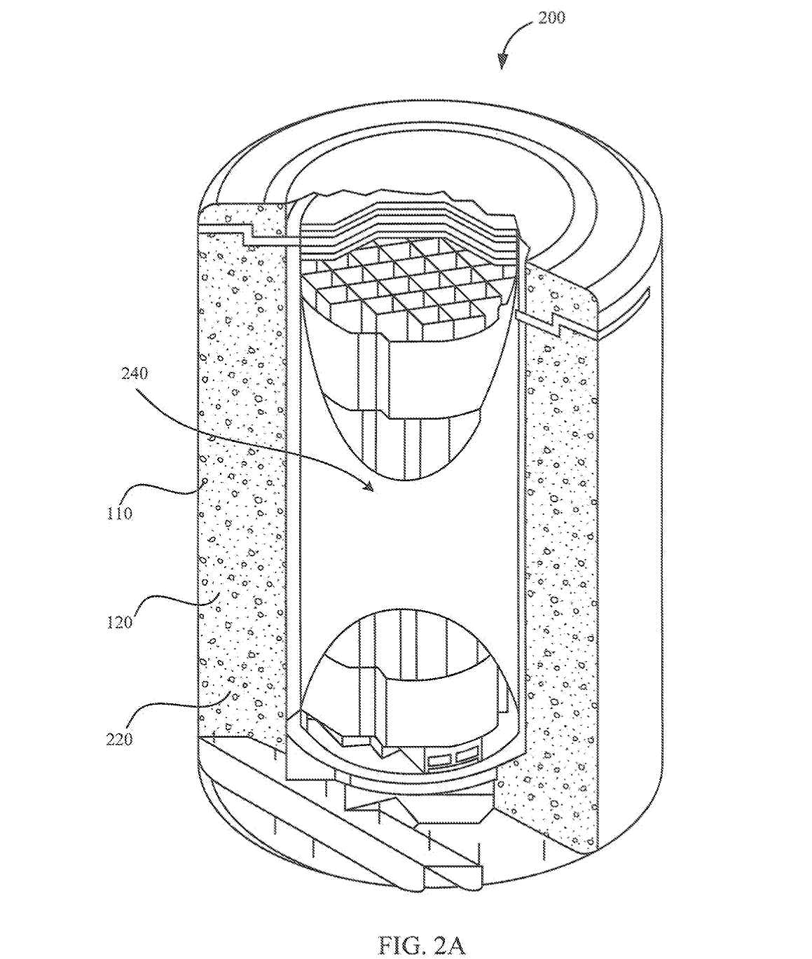

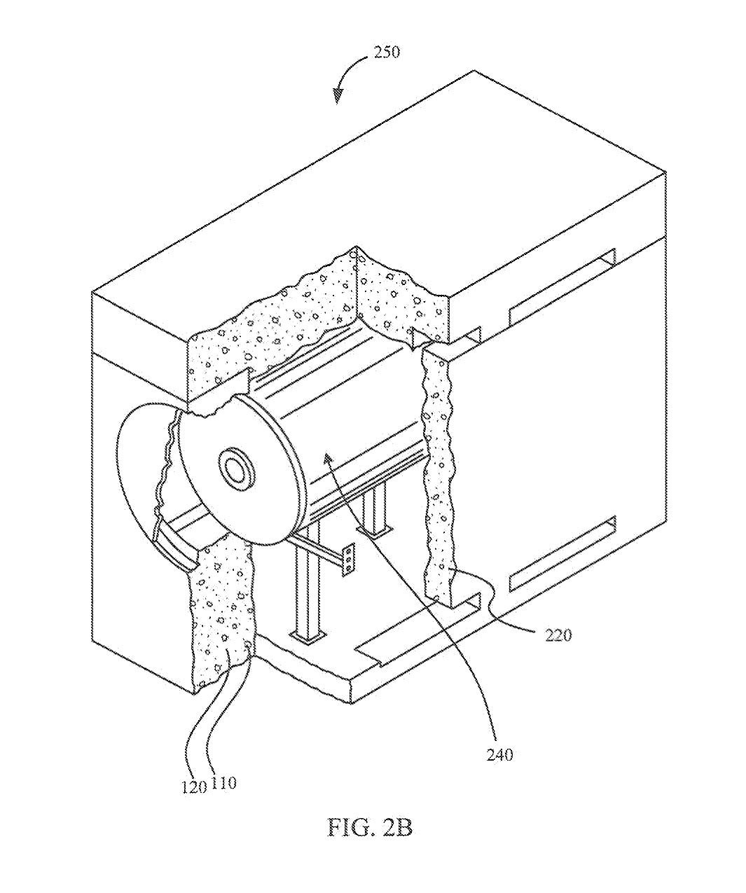

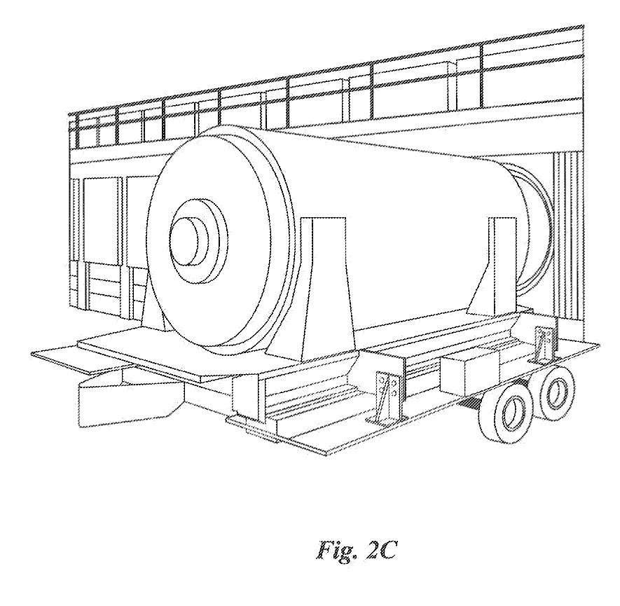

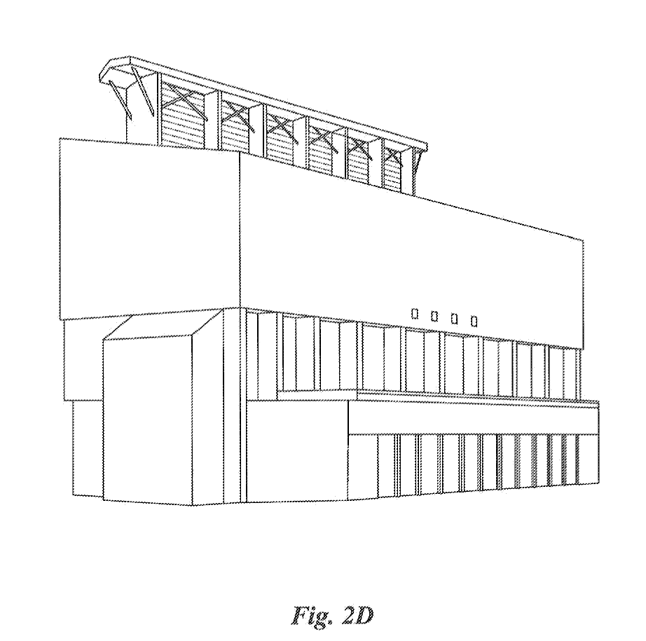

FIGS. 2A and 2B show two exemplary storage casks 200, 250 according to various embodiments. The casks 200, 250 may comprise borated concrete-rubber 220, with boron 120 and rubber 110 that surround an interior enclosure 240. The interior enclosure 240 may include a chamber for storage of radioactive material, for example, spent nuclear fuel or rods, radioactive materials, etc. The interior enclosure 240 may include containment shells, lead shells, baskets, etc. The casks may be used for storage and/or shipping. FIGS. 2C and 2D show large storage facilities that may be constructed with borated concrete-rubber as described in various embodiments.

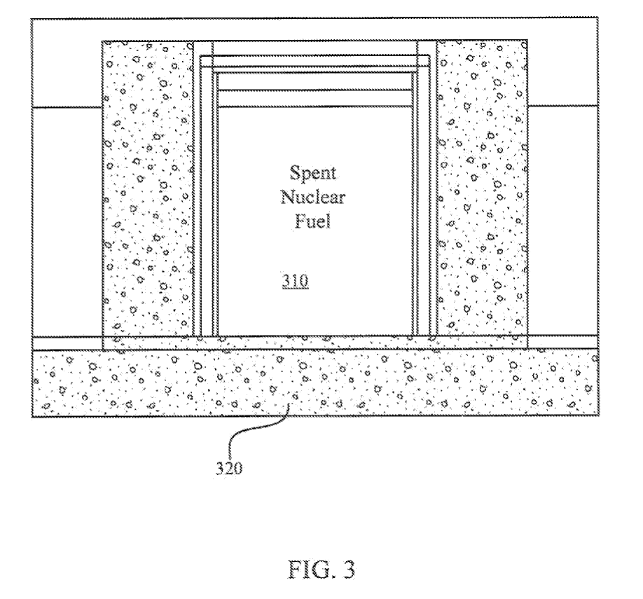

FIG. 3 shows a spent nuclear fuel facility that may be constructed using borated concrete-rubber 320 according to another embodiment. The borated concrete-rubber 320 encloses a container of spent nuclear fuel 310. In this embodiment shown in the figure, the borated concrete-rubber 320 surrounds only a portion of the spent nuclear fuel. As shown, the borated concrete-rubber 320 is used along the wall and the floor of the enclosure. A lid may also be used that includes borated concrete-rubber as well.

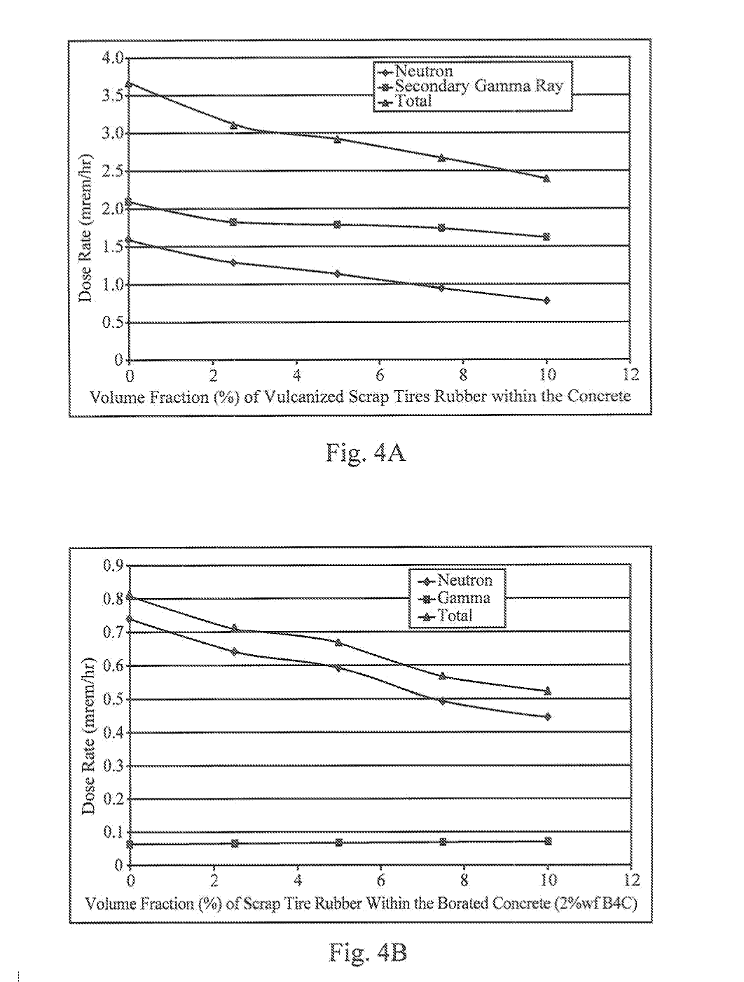

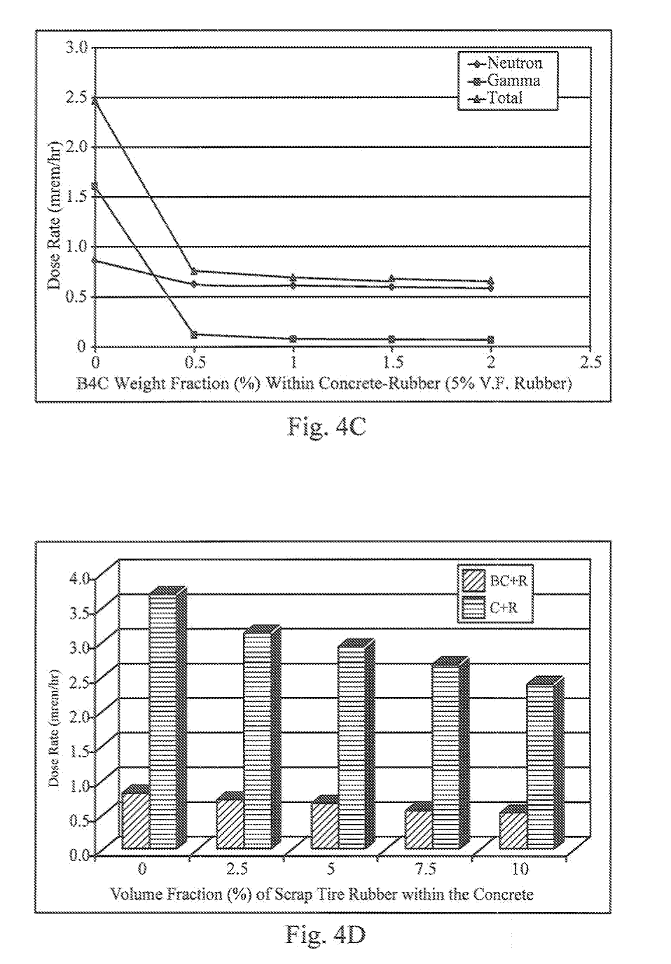

FIGS. 4A, 4B, 4C and 4D show various graphs detailing the shielding benefits of borated concrete-rubber according to various embodiments. Specifically, FIG. 4A shows how the shielding dose rate varies with the volume of vulcanized rubber within concrete, without boron included. As shown, the greater the percentage of rubber within the concrete, the lower the dose ratio from both neutron and secondary gamma ray radiation.

FIG. 4B shows dose rate variation according to the volume of vulcanized rubber within borated concrete. As shown, the greater the percentage of rubber within borated concrete, the lower the dose rate from neutron penetration. The introduction of boron carbide keeps the dose rates due to secondary gamma ray penetration below 0.1 mrem/hr for spent nuclear fuel cask designed structure regardless of the quantity of vulcanized rubber included.

FIG. 4C shows how the dose rates vary as a function of boron carbide weight fraction within concrete-rubber. The concrete, in one embodiment, contains 5% rubber by volume. As shown, the effectiveness of boron carbide within the concrete-rubber significantly improves the concrete radiation protection properties. A relatively small percentage of boron carbide within concrete-rubber increases the effective shielding against neutron fluence. In contrast a much larger volume of boron carbide is required in regular concrete (without rubber) to achieve the same radiation protection properties; resulting in significant construction cost saving.

FIG. 4D shows a comparison of the dose rates values between borated concrete-rubber and concrete-rubber (without boron). As can be seen in the figure there is an order of magnitude difference between the dose rate reduction of the concrete-rubber and the borated concrete-rubber using the same shielding thickness.

Boron and/or boron containing compounds as well as rubber may also be added to mortars, stuccos and/or grouts. Borated concrete-rubber slabs may be created for various applications, such as for walls, ceilings, enclosures, casks, barrels, and/or floors in a radiation environment. Various mixtures of cement, water and aggregate may be used. Borated concrete-rubber may also be used to create building blocks and/or bricks that may be used to construct structures that required radiation protection. As another example, boron and rubber containing bricks may be created and used with boron and rubber containing mortar to create a radiation shielding wall and/or a structure.

Any type of cement or cement containing material may be used in any of the embodiments disclosed herein. For example, cement may include type I, Type Ia, type II, type IIa, type III, type IIIa, type IV and type V Portland cements (using either the ASTM C150 standard or the European EN-197 standard), hydraulic cements, non-hydraulic cements, Portland flyash cement, Portland Pozzolan cement, Portland silica fume cement, masonry Cements, mortars, EMC cements, stuccos, plastic cements, expansive cements, White blended cements, Pozzolan-lime cements, slag-lime cements, supersulfated cements, calcium aluminate cements, calcium sulfoaluminate cements, geopolymer cements, Rosendale cements, polymer cement mortar, lime mortar, and/or Pozzolana mortar.

Any Boron isotope or compound may be used in any of the embodiments described herein. For example, a borated concrete-rubber may include enriched boron (¹⁰B), borosilicates, boric acid, boron carbide, boron containing fibers, boron containing fabrics, boron containing mesh, boron filaments, borax, boron oxide, ferroboron and borated stainless steel, colemanite, kernite, ulexite, kernite, tincal, boron nitride, borates, or a mixture of any of the above. In another embodiment, boron, boron isotopes, and/or boron compounds may be combined with cement in a powder form or as pellets. Powdered Boron has an increased surface area that may be ideal for radioactive shielding.

Any type of rubber, rubber compound, or rubber containing material may be used in the various embodiments disclosed herein. For example, rubber may include vulcanized rubber, non-vulcanized rubber, recycled rubber, rubber from used tires, rubber by products, synthesized rubber, natural rubber, latex, or a mixture of any of the above. Car tires include a number of materials beside rubber. For example, a typical automotive tire includes approximately 14% natural rubber, 27% synthetic rubber, 28% carbon black, 14-15% steel, and 16-17% fabric, filler, accelerators, antiozonants, etc. As another example, a typical truck tire includes approximately 27% natural rubber, 14% synthetic rubber, 28% carbon black, 14-15% steel, and 16-17% fabric, filler, accelerators, antiozonants, etc.

In one embodiment, borated concrete-rubber may include 1-20% rubber by weight or volume. For example, borated concrete-rubber may include about 1%, 2%, 3%, 4%, 5%, 6%, 7%, 8%, 9%, 10%, 11%, 12%, 13%, 14%, 15%, 16%, 17%, 18%, 19%, or 20% rubber by weight or volume. In another embodiment, the material may include 20-40% cement by weight or volume. For example, borated concrete-rubber may include about 20%, 21%, 22%, 23%, 24%, 25%, 26%, 27%, 28%, 29%, 30%, 31%, 32%, 33%, 34%, 35%, 36%, 37%, 38%, 39%, or 40% cement by weight or volume. In another embodiment, a borated concrete-rubber may also include 0.1-10% boron or boron containing compound, for example, boron carbide by weight or volume. For example, boron concrete-rubber may include about 0.1%, 0.3%, 0.5%, 0.7%, 0.9%, 1.1%, 1.3%, 1.5%, 1.7%, 1.9%, 2.1%, 2.3%, 2.5%, 2.7%, 2.9%, 3.1%, 3.3%, 3.5%, 3.7%, 3.9%, 4.1%, 4.3%, 4.5%, 4.7%, 4.9%, 5.1%, 5.3%, 5.5%, 5.7%, 5.9%, 6.1%, 6.3%, 6.5%, 6.7%, 6.9%, 7.1%, 7.3%, 7.5%, 7.7%, 7.9%, 8.1%, 8.3%, 8.5%, 8.7%, 8.9%, 9.1%, 9.3%, 9.5%, 9.7%, 9.9% or 10.1% boron or boron containing compound by weight or volume. Various other combinations may be employed without deviating from the spirit of this disclosure.

A binding compound may be included with a mixture of concrete rubber prior to hydration according to one embodiment. In some embodiments, such binders may improve the strain compatibility of cement and rubber. A binding compound may function as an elastic binder to increase the flexibility of the hardened cement and, therefore, improves the strain compatibility of the rubberized construction material. Moreover, in various embodiments, the rubber may be in the form of granules, pellets, crumbs, strings, webs, fabrics, fibers, powders, chunks, lumps, bits, pebbles, etc.

While the principles of the disclosure have been described above in connection with specific apparatuses and methods, it is to be clearly understood that this description is made only by way of example and not as limitation on the scope of the disclosure.

What is claimed is:

1. A radiation shielding material comprising:
cement;
rubber; and
boron.

2. The radiation shielding material according to claim 1, wherein the radiation shielding material comprises about 1% to about 20% rubber by weight.

3. The radiation shielding material according to claim 1, wherein the radiation shielding material comprises about 0.1% to about 10% boron by weight.

4. The radiation shielding material according to claim 1, wherein the radiation shielding material comprises about 20% to about 40% cement by weight.

5. The radiation shielding material according to claim 1, wherein the radiation shielding material comprises about 5% to 15% water by weight.

6. The radiation shielding material according to claim 1, wherein the boron comprises boron carbide.

7. The radiation shielding material according to claim 1, wherein the boron comprises a boron containing powder.

8. The radiation shielding material according to claim 1, wherein the cement includes Portland cement.

9. The radiation shielding material according to claim 8, wherein the Portland cement adheres to the ASTM C150 standard.

10. The radiation shielding material according to claim 1, wherein the rubber includes granulated used tires.

11. The radiation shielding material according to claim 1, wherein the rubber includes a combination of synthetic rubber and natural rubber.

12. An apparatus for shielding and housing radioactive material, comprising:
an interior space configured to house radioactive materials; and
a exterior structure that at least partially defines the boundaries of the interior space, said structure comprising Portland cement, boron carbide and rubber granules.

13. The apparatus for shielding and housing radioactive material according to claim 12, wherein the structure is a nuclear waste storage cask.

14. The apparatus for shielding and housing radioactive material according to claim 12, wherein the structure is a radioactive material storage facility.

15. The apparatus for shielding and housing radioactive material according to claim 12, wherein the structure is a nuclear power plant.

16. A method for producing a radiation shield mixture, comprising:
providing Portland cement;
mixing a powdered boron containing compound with the Portland cement; and
adding rubber granules to the Portland cement mixture.

17. The method according to claim 16, further comprising hydrating the Portland cement mixture with water.

18. The method according to claim 16, further comprising mixing aggregates with the Portland cement mixture.

19. The method according to claim 16, further comprising adding binders to the Portland cement mixture.

20. The method according to claim 16, wherein the boron containing compound further comprises boron carbide.

21. The method according to claim 16, wherein the rubber granules are produced from automobile tires or truck tires.
